(19) United States
(12) Patent Application Publication
(10) Pub. No.: US 2004/0252309 A1
(43) Pub. Date: Dec. 16, 2004

(54) Interferometer, a method of providing an interferometer, a light emitter, and a means for moving a mirror

(76) Inventor: Andreas Frandsen, Slangerup (DK)

Correspondence Address: HARNESS, DICKEY & PIERCE, P.L.C., P.O. BOX 8910, RESTON, VA, 20195, US

(21) Appl. No.: 10/857,950

(22) Filed: Jun. 2, 2004

Related U.S. Application Data
(60) Provisional application No. 60/477,336, filed on Jun. 11, 2003.

(51) Int. Cl. G01B 9/02

(52) U.S. Cl. 356/451

(57) ABSTRACT

A compact interferometer and a moving means and a light emitter for an interferometer. The compact interferometer has increased light throughput and may be provided in a single block of e.g. metal in order to be easier to manufacture, set up, align and in which the atmosphere is more easily controlled. The moving means has a rigid magnet part travelling within a coil part, increasing the stiffness and controllability of the system. The light emitter is a filament having a bifilar coil where no part of the filament extends within the coil.

The present invention relates to interferometers and spectrometers comprising such an interferometer, and in particular to compact interferometers being more “light economic”.

Standard interferometers are normally multi-purpose interferometers having very long light paths and thereby large losses of light along the light path. Long light paths provide problems in that vapour present in the cavity will absorb the light—or at least some wavelengths, which makes measurements more difficult in that this absorption needs to be quantified and corrected. The longer the light path, the larger the need for reducing the vapour (drying out the cavity) and maintaining a fixed temperature in the cavity. Even small variations may be detected and may ruin measurements.

In addition, longer light paths require larger—and more expensive—optical elements, such as mirrors and beamsplitters. In fact, larger optical elements require thicker substrates in order to maintain their shapes. Also, due to the fact that the beamsplitter is angled 45° in relation to the directions of the incident light, a thicker beamsplitter actually has a relatively smaller effective diameter, unless its actual diameter is increased even further. Thus, the cost of the interferometer increases vastly, and the amount of light lost in the cavity increases.

The present invention relates to a solution, where a compact interferometer is provided which may be made very “light economic” in the sense that much less light may be lost along the light path between the light emitter and the detector.

In a first aspect, the invention relates to an interferometer having:

a light emitter,

a beamsplitter for dividing light emitted from the light emitter into a first and a second light beam,

a first mirror for returning the first light beam to the beamsplitter,

a second mirror for returning the second light beam to the beamsplitter, and

a detector for receiving, from the beamsplitter, interfering light from the first and second light beams,

wherein the relative positioning of the light emitter, the beamsplitter, the first and second mirrors, and the detector is so that a shortest light path from the light emitter to the detector via the beamsplitter to one of the first and second mirrors and back to the beamsplitter, is shorter than 100 mm.

In the present context, the shortest light path will be the path the light takes from light emitter to the beamsplitter, to a mirror and back to the beamsplitter and to the detector. Longer light paths may be experienced due to undesired reflections, but these are not considered in the present context. The light path distance may vary slightly depending on where on the mirrors/beamsplitter, the light is reflected/transmitted. The shortest light path is that of these different path lengths which is the shortest.

A light emitter may be any type of e.g. element emitting light. The presently preferred light emitter is a filament which will be described further below.

In the present context, a beamsplitter is an optical element which partly transmits and partly reflects light. It normally also makes the two returned light beams interfere simply by transmitting these in a common direction (but overlapping).

Preferably, in fact, the relative positioning of the light emitter, the beamsplitter, the first and second mirrors, and the detector is so that a shortest light path from the light emitter to the detector via the beamsplitter to one of the first and second mirrors and back to the beamsplitter, is shorter than 90 mm, such as shorter than 80 mm, preferably shorter than 70 mm, such as shorter than 68 mm.

The interferometer may be a spectrometer, when it further comprises:

means, at a predetermined position of a light path between the emitter and the detector, for providing light to and receiving light from a sample, and

means for determining, on the basis of an output of the detector, a characteristic of the sample.

In this context, the predetermined position may be anywhere in the light path. Normally, it will be positioned outside the light path between the beamsplitter and the mirrors.

A large number of manners exist for having a light beam and a sample interact. The light may be directed away from its path, in order to reach the sample, and be redirected back into the path in order to reach the detector, or the detector may be moved to a suitable location in order to receive the light.

In a preferred embodiment:

the providing and receiving means are adapted to provide light to and receive light from a container means adapted to hold a liquid, powder, or fluid sample, and

the determining means are adapted to determine a concentration of at least one component of the sample.

In this embodiment, the sample may be provided in the light path directly from the beamsplitter to the light detector or from the light emitter to the beamsplitter. Naturally, this sample and the means holding it (normally a cuvette) will take up part of the light path. Thus, in this embodiment, the shortest light path between the light emitter and the detector, apart from the position at the container, may be present in air (but not necessarily ambient air) such as dried/dry air, and this part of the shortest light path from the light emitter to the detector via the beamsplitter to one of the first and second mirrors and back to the beamsplitter, which is present in air, is preferably shorter than 90 mm. In fact, preferably, this part, present in air, of the shortest light path is shorter than 80 mm, preferably shorter than 70 mm, such as shorter than 60 mm.

Other types of samples are not positionable in the light path, whereby other types of solutions are desired. A sample of that type is measured by another embodiment wherein the providing and receiving means are adapted to provide light to and receive light from a surface and direct the received light to the light detector. In this embodiment, the shortest light path includes the light path back and forth to the surface.

Preferably, the beamsplitter is circular and has a diameter of at the most 20 mm, such as at the most 18 mm, preferably at the most 15 mm, such as at the most 12 mm. The larger the diameter, the larger the price of the beamsplitter.

Another parameter which greatly influences the price of the beamsplitter is the thickness thereof. It is important that the beamsplitter maintains its shape also during vibration. In the present context, the beamsplitter may have a thickness of at the most 3 mm, such as at the most 2 mm, preferably at the most 1.5 mm. The thickness also affects the actual diameter of the beamsplitter in that it reduces the useful area of the beamsplitter (when the light is transmitted there through at a 45° angle).

Vibrations make things vibrate at their eigenfrequencies. Preferably, the eigenfrequencies of critical elements are high and away from naturally occurring vibration frequencies. Thus, the presently preferred beamsplitter has an eigenfrequency of at least 1 kHz, such as at least 2 kHz, preferably at least 4 kHz, such as at least 10 kHz.

Also the size of the mirrors has an influence on the price of the interferometer. Thus, preferably, the first and second mirrors are circular and have a diameter of at the most 14 mm, such as at the most 12 mm, preferably at the most 10 mm.

Up to a certain limit, the more light, which is detected in the interferometer, the better the measurement. This depends a.o. on the size of the light sensitive area of the detector which, preferably, is at least 1.5 mm², such as at least 2 mm², preferably at least 3 mm².

A number of external factors interact with the measurement, such as temperature variations, humidity and humidity variations. Thus, in a preferred embodiment, it is desired to control these factors.

Preferably, the light emitter, the beamsplitter, the first and second mirrors, and the detector are positioned inside a single block of a material, such as a metal, preferably aluminium.

Naturally, the block of material may, alternatively, be assembled from several pieces which may, in fact, be of different materials. Providing the elements into a single block has the advantage that it may be worked with suitable precision which may ease the assembly of the interferometer.

One advantage of that embodiment is seen when setting up and aligning the system, which will become clear further below.

In order to obtain interferograms, one of the first and second mirrors preferably is adapted to be translated along a direction between a mirror and the beamsplitter, the interferometer then further comprising means for moving the mirror.

Then, in the last mentioned preferred embodiment, the moving means may be provided in another or the same block of material. When the moving means are provided in another block, this block may be attached to the (single) block.

It may be desired to render the (single) block at least liquid tight in order to keep the optical elements and the light path sufficiently dry. A gas tight interferometer will be more easily kept dry in humid surroundings.

The preferred light emitter comprises a filament comprising two end parts and a central part, wherein the central part is coiled in a manner so that no parts (taken across the length of the filament) of the filament extend inside the coil and so that the two end parts extend from a same end of the coil. This type of winding may be termed a bifilar winding.

Preferably, the two end parts extend at least substantially downwards in relation to the central part. In this manner, the heat generated (but not utilized for light emission) in these parts will rise to the glowing centre of the filament and then not merely be lost.

In a preferred embodiment, the interferometer is a Michelson interferometer.

A second aspect of the invention relates to a moving means for an interferometer, the moving means comprising a magnet part and a coil part for receiving a voltage/current in order to have the magnet part and the coil part exert a force there between, wherein the magnet part extends within the coil part and through the coil(s). A similar moving means may be seen in the Applicant's WO 96/24832A1 where the coil part extends within the magnet part.

A problem, however, encountered in the prior art method is the fact that the moving part can either not be made of a sufficiently stiff material or that the coils will short circuit (magnetically, inductically, and/or electrically) if positioned on a metal base. If a non-metal base is used, it may be less stiff and may actually be bent/deformed during acceleration thereof. Another problem is the fact that the windings of the coil(s), due to the forces exerted, may be displaced due to the forces exerted, which will bring about a mismatch between the movement expected and that achieved. Fixing the coils on the outer part will enable a better fixing thereof.

Preferably, the magnet part comprises at least one magnet enclosed in a metal tube, such as a tube of aluminium, providing a stiffness sufficient to drive the mirror without vibrations or deformations. Another advantage of the use of the metal tube is that the metal, even though a non-magnetic or almost non-magnetic material is preferred, it will still affect the movement of the magnet part by slightly breaking it, easing the control of the acceleration/movement thereof.

Naturally, the metal tube may have any cross section, but a circular cross section is preferred in order to obtain an even magnetic field inside the coils.

Also, the moving means may comprise electronics for providing current/voltage to the coil(s) and receiving current/voltage from the coil(s) as well as deriving information relating to a velocity/acceleration of the magnet part and controlling that velocity/acceleration.

Further, the moving means may comprise means, such as leaf springs, for maintaining the magnet part inside the coil part during the movement.

A third aspect of the invention relates to a light emitter for an interferometer, the light emitter comprising a filament comprising two end parts and a central part, wherein the central part is coiled in a manner so that no parts (full cross-sectional parts of the filament) of the filament extend inside the coil and so that the two end parts extend from a same end of the coil.

This light emitter may be made very light intensive while having low power consumption.

A fourth aspect of the invention relates to a method of providing an interferometer, the method comprising:

providing a block of one or more predetermined materials,

providing a first bore along a predetermined first direction in the block,

providing a second bore at a second direction at an angle to the first direction, the first and second bores intersecting at a predetermined point in the block,

providing a first mirror into the first bore at a first position thereof,

providing a light emitter into the first bore at a second position thereof,

providing a detector at a position where it is able to detect light travelling along the second bore,

providing a second mirror into the second bore at a first position thereof,

one of the first and second mirrors being movable in a direction along the direction of the first or second bore, respectively,

providing a beamsplitter into a bore and at the predetermined position, a direction of the beamsplitter being defined by the direction of the bore, and

adjusting the interferometer by adjusting the other of the first and second mirrors in relation to the direction of the first or second bore, respectively.

Preferably, the block is a single block of a predetermined material. However, the block may be assembled by a number of pieces of one or more materials.

Preferably, the method further comprises providing a third bore in a predetermined angle in the block, the third bore extending to the predetermined point in the block, and wherein the step of providing the beamsplitter comprises providing the beamsplitter in the third bore.

In general, the providing of a bore may be either assembling the block of different pieces which, when assembled, defines the bore or providing the bore by e.g. drilling it directly into the block or a piece thereof.

In the present context, the adjustment will be an adjusting of the adjustable mirror to alter its direction in relation to the direction of the bore. Preferably, the one mirror is not adapted to have its direction altered in relation to the direction of its bore, so that the only alignment of the interferometer is the adjustment of the other mirror.

Providing the optical elements within the block both eases the manufacture of the interferometer, eases the setting up and alignment, and makes it easier to control the atmosphere therein.

Also, the individual optical elements may be provided so as to be independent of their rotation (or at least to tolerate a predetermined rotation) around the direction of the bore.

Preferably:

the step of providing the first bore comprises providing the first bore as a first through-bore along the predetermined first direction in the block,

the step of providing the second bore comprises providing the second bore as a second through-bore along the second direction,

the step of providing the first mirror comprises providing the first mirror into the first though-bore from a first end thereof,

the step of providing the light emitter comprises providing the light emitter into the first through-bore from a second end thereof, and wherein

the step of providing the second mirror comprises providing the second mirror into the second through-bore from a first end thereof.

Also, preferably, the step of providing the detector comprises providing the detector at a second position within the second bore, the method further comprising the step of providing means for having light travelling in the second bore interact with a sample and for re-introducing the light from the sample into the second bore.

In the preferred embodiment, the method provides a Michelson interferometer, and wherein:

the step of providing the second bore comprises providing the second bore with the second direction being at least substantially perpendicular to the first direction,

the step of providing the third bore comprises providing the third bore along a third direction being at least substantially 45° to the first and second directions,

the step of providing the one of the first and second mirrors comprises providing the one mirror with a plane at least substantially perpendicular to the direction of the through-bore into which the mirror is provided,

the step of providing the other of the first and second mirrors comprises providing the other mirror so as to have a plane of the other mirror adjustable to be at least substantially perpendicular to the direction of the through-bore into which the mirror is provided, and

the step of providing the beamsplitter comprises providing a beamsplitter having a plane being at least substantially perpendicular to the direction of the third bore.

In the fourth aspect, the method further preferably comprises the step of providing a moving means adapted to move the one of the first and second mirrors, in order to obtain interferograms. Then, the step of providing the moving means could comprise providing the moving means into the first or second bore in the (single) block. Alternatively, the step of providing the moving means could comprise providing the moving means in a separate block and attaching the (single) block and the separate blocks to each other.

It may be desired to have the method comprise the step of closing or sealing the first, second, and third bores subsequent to the steps of providing the mirrors, beamsplitter, and detector.

A fifth and final aspect of the invention relates to a method of making a light emitter, the method comprising:

providing a filament having a central part and two end parts,

shaping part of the central part into an S-shape,

coiling parts of the central part adjacent to the S-shaped part into bifilar coils having at one end thereof the S-shaped part and so that the end parts extend from another end of the coils.

In the following, the preferred embodiment will be described with reference to the drawings, wherein:

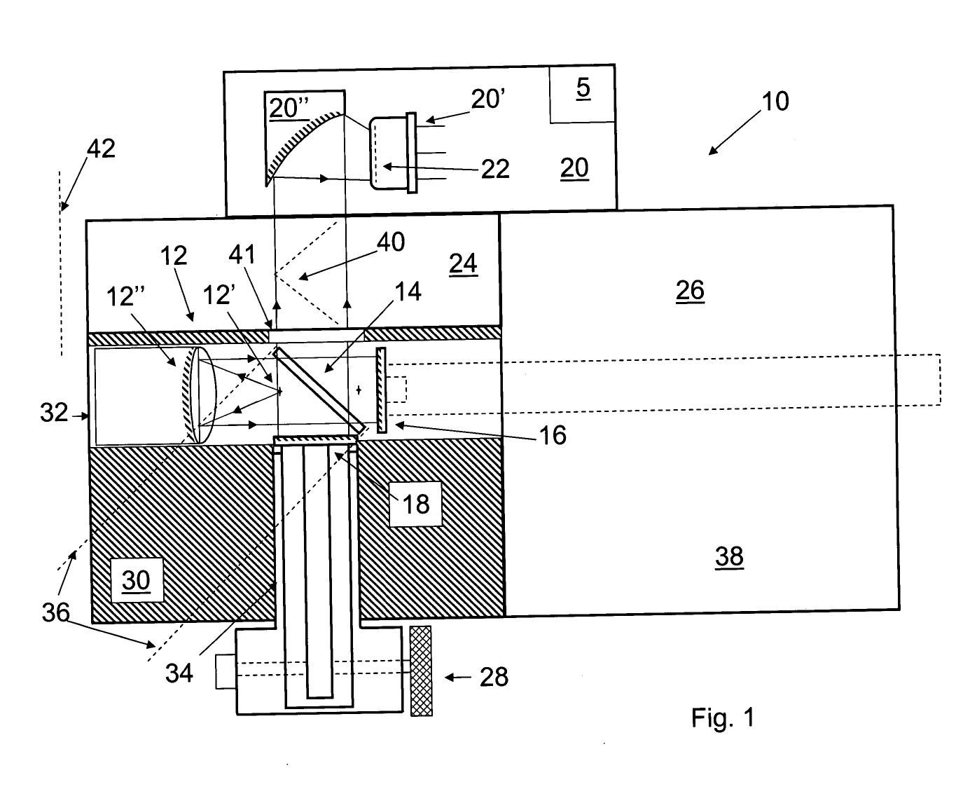

FIG. 1 illustrates the optical setup of the preferred embodiment,

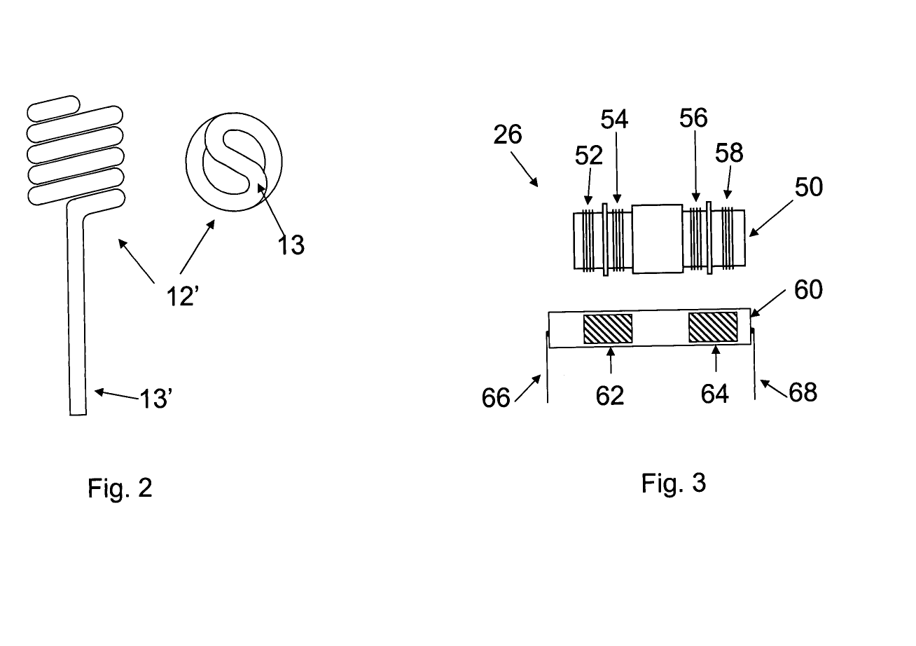

FIG. 2 illustrates the preferred filament for the light emitter, and

FIG. 3 illustrates the preferred moving means for the movable mirror.

In FIG. 1, the preferred embodiment, a spectrometer based on a Michelson interferometer is seen. This interferometer 10 comprises a light emitter 12 comprising a filament 12′ and a parabolic mirror 12″ (focal length 12 mm, with a diameter of 12 mm), a beamsplitter 14, a movable, plane mirror 16, a stationary, plane mirror 18, and a detector 20 comprising a detector element 20′ and a parabolic (focal length 6.5 mm, with a diameter of 12 mm) collecting mirror 20″. The collector element 20′ has a light sensitive surface 22.

A processor 5 is provided for controlling the movement of the mirror 16 and for receiving the output of the detector 20 and for determining, e.g., a characteristic of a sample present in the cuvette 24 or at/on/in the surface 42.

Between the beamsplitter 14 and the detector 20, a cuvette 24 is provided for holding a liquid or fluid sample during measurement. Alternatively, light may be directed (by means indicated by 40 (used instead of the cuvette 24) from the beamsplitter 14 to e.g. a surface (indicated by 42), collected there from (by the means 40), and directed to the detector 20.

Translation of the movable mirror 16 is performed using a motor 26, which is described further below with reference to FIG. 3.

Aligning of the spectrometer/interferometer may be obtained solely by tilting the mirror 18 using a tilting mechanism 28.

The filament 12′ is as that seen in FIG. 2. This filament (made of Inconel 601, 0.3 mm diameter) is wound (4½ full circles) around a 0.85 mm thick element bifilarly, which means that the central portion has two coils interconnected at one end with an S-shaped part 13 and where power is provided to the other ends 13′ of the coils. No part (that is: no full cross section across the width of the filament) of the filament extends inside the coil. This 1V, 2 A, 2 W light emitter has an overall size corresponding to a diameter of 1.6 mm or less and provides an intensity of 0.45 mW/mm² at the mirror 20″.

The detector is a pyroelectric detector (DLATGS from BAE systems) having a light sensitive area with a diameter of 2 mm.

The beamsplitter 14 has a diameter of 12.7 mm (½ inch) and is desired to have a 50% reflectivity over the wavelength interval of 3-10 μm. The beamsplitter base material has a thickness of 1 mm. Naturally, the beamsplitter 14 comprises a compensator plate (not illustrated) in order to compensate for the—otherwise—unequal number of transmissions through the beamsplitter base material.

The thickness of the beamsplitter is chosen so that the beamsplitter is sufficiently stiff to maintain its shape (flatness)—also during vibrations or the like. However, thicker beamsplitters are a lot more expensive than thinner substrates, and the same applies to lower diameter beamsplitters compared to larger diameter beamsplitters. In addition, thicker beamsplitters actually have a lower real diameter in that the thickness of the substrate reduces (when angled 45°) the opening in which the light may pass the beamsplitter.

The mirrors 16 and 18 are gold plated brass—10 mm in diameter. The 10 mm have been selected due to the fact that the mirrors should be larger than the projection of the beamsplitter (in the 45° angle) thereon.

Not illustrated is also a laser which emits light into the spectrometer for use in the equidistant sampling (of the detector) of the light intensity. This technique is standard in FTIR interferometers.

The distances, from the centre of the beamsplitter 14, are:

to the centre of the mirror 16: 7 mm (±½ mm due to the translation of the mirror),

to the centre of the mirror 18: 7 mm,

to the centre of the mirror 12″: 13 mm, and to the cuvette 24: 7 mm,

and the distance from the cuvette 24 to the element 22 is 13 mm.

Manufacture of the present spectrometer comprises providing a single block of aluminium 30. In this block 30, two through-bores 32 and 34 are made. These through-bores 32 and 34 are perpendicular to each other.

At the centre of the two through-bores 32 and 34, the beamsplitter 14 is to be positioned. This beamsplitter 14 is provided through a third bore 36 illustrated by two hatched lines. This bore is 45 degrees to the two through-bores 32 and 34 and out of the plane of FIG. 1.

Having made the bores 32, 34, and 36, the light provider 20 is introduced from one end of the through-bore 32, and the mirror 16 from the other end. The mirror 18 is introduced from one end of the through-bore 34, and the beamsplitter 14 is introduced via the third bore 36. The precision of the tilting of the light provider 20, the beamsplitter 14 and the mirror 18 is defined by the precision of the direction of the bores. The mirror 16 has a direction defined by the springs 66 and 68. In an alternative embodiment, the mirror 16 may be defined by guides interacting between the mirror 16 and the bore 32.

The rather delicate alignment of the spectrometer 10 may then be obtained simply by tilting one mirror, that is, the mirror 18, using a tilting mechanism 28 to which the mirror 18 is attached and which extends out of the through-bore 34 for manipulation purposes.

The present spectrometer 10 may be made as liquid or gas tight as may be desired. It is seen that the individual through-bores 32 and 34 as well as the bore 36 may be totally closed subsequent to introduction of the individual optical elements.

Gas tight or liquid tight operation may be desired due to the interference of especially water molecules with the infrared light travelling in the interferometer. However, due to the compact nature of the spectrometer, it may be desired only to maintain a constant temperature and moisture level in the small cavity of the interferometer.

The motor 26 may also be introduced into the block 30 or may be provided in a separate block 38, which is then attached to the block 30. Also, the motor may be made as liquid/gas tight as may be desired.

The light output from the optical “compartment” may be output through a window 41, and the detector “arm”, in which the detector 20 is positioned, may also be made as liquid/gas tight as desired, such as by the use of a window (not illustrated). This detector “arm” may also be made in the same block of material 30. Then, the cuvette 24 or any optics used for directing the light to and from the spectrometer (for use in e.g. measurements on surfaces or larger samples) may be provided in a cut-out part of the block 30.

The motor 26 is illustrated in more detail in FIG. 3, wherein an outer tube 50 comprises two pairs of coils, motor coils 56 and 58 and sensor coils 52 and 54. This outer tube may be provided in the block 30 or in another block attached thereto.

An inner tube 60 (illustrated outside the outer tube 50) is movably positioned inside the outer tube 50 and comprises therein two magnets 62 and 64.

The operation of the motor is that the motor coils 56 and 58 receive a triangle-shaped current, whereby electromagnetic fields are generated which interact with the magnet 64 and provides longitudinal back and forth translation of the inner tube 60. The movement is controlled by leaf springs 66 and 68 (attached to the block in which the tubes 50 and 60 are provided) adapted to facilitate longitudinal translation of the inner tube 60 but at least substantially prevent translations in other directions.

The sensor coils 52 and 54 sense the movement of the magnet 62 and provide a velocity feedback for controlling electronics (not illustrated) for increased control of the mirror movement.

The present motor has the advantage that the inner tube 60 may be light and very stiff, providing a very high eigenfrequency and a very low vibration sensitivity of the system.

### COMPARISON EXAMPLE

### Light Intensity Loss In The System

A system as illustrated in FIG. 1 is compared to an existing, marketed FTIR instrument, the FOSS Milkoscan FT 120, having:

a filament having a diameter of 4,5 mm, requiring 13 W and providing an intensity of 0.40 W/mm² at the light source mirror,

a parabolic light source mirror (38 mm×28 mm with rounded corners) and a focal length of 36 mm,

a detector mirror having a diameter of 21 mm and a focal length of 15 mm, two plane mirrors with a diameter of 50 mm,

a pyroelectric detector having a light sensitive area with a diameter of 2.5 mm, and

a beamsplitter having a diameter of 25 mm and a thickness of 3.5 mm, providing (taking into account the thickness of the beamsplitter and the compensator plate) an effective diameter, seen from the plane mirrors, of only 15 mm,

wherein the distances are:

from the filament to the light source mirror: 42 mm,

from the light source mirror to the beamsplitter: 80 mm,

from the centre of the beamsplitter to the centre of the moving, plane mirror: 18 mm,

from the centre of the beamsplitter to the centre of the fixed, plane mirror: 18 mm,

from the centre of the beamsplitter to the cuvette: 30 mm,

from the cuvette to the detector mirror: 25 mm, and

from the detector mirror to the detector element: 20 mm.

Thus, the total length from the filament to the detector element via the beamsplitter to one of the plane mirrors and back to the beamsplitter is 233 mm

Even though the above FT120 instrument has a filament providing more than six times the light intensity (power consumption) of that of the preferred embodiment, and a larger light source mirror to provide more light into the actual interferometer, the light intensity at the detector is less than twice (3.4 mW compared to in excess of 2 mW) that of the preferred embodiment. The reason for this is the more compact nature of the interferometer and the resulting lower diameter and thickness of the beamsplitter.

### Measuring In Aqueous Samples

The present spectrometer may be especially adapted to perform measurements in aqueous samples. Aqueous samples absorb heavily in the IR region, and the absorption peaks of components in aqueous samples are widened due to the coupling with the water molecules.

The increased intensity throughput of the present invention is advantageous when used with highly absorbing samples. Also, the widened peaks make it possible to use a higher divergence in the interferometer.

Increasing the divergence, such as to 3.4° at each side of the centre of the beam, will increase the intensity throughput but reduce the frequency resolution of the interferometer. This, however, is acceptable due to the widened absorption peaks. An absorption peak in e.g. milk has a width of about 16 cm⁻¹.

Also, the wide absorption peaks make it possible to actually measure faster in that a shorter distance of movement of the mirror 16 is required in order to obtain the frequency resolution required to measure the absorption peaks of the aqueous solution. Presently, a measurement is performed on the basis of 20 scans, each scan taking one second (movement of the mirror 16 back and forth once). Thus, one measurement may be performed in 20 seconds.

A much higher cadence is obtainable by scanning fewer times and increasing the speed of the mirror 16. Summing of the scans may also be performed with scans of different lengths.

1. An interferometer having:
a light emitter,
a beamsplitter for dividing light emitted from the light emitter into a first and a second light beam,
a first mirror for returning the first light beam to the beamsplitter,
a second mirror for returning the second light beam to the beamsplitter, and
a detector for receiving, from the beamsplitter, interfering light from the first and second light beams,
wherein the relative positioning of the light emitter, the beamsplitter, the first and second mirrors, and the detector is so that a shortest light path from the light emitter to the detector via the beamsplitter to one of the first and second mirrors and back to the beamsplitter, is shorter than 100 mm.

2. An interferometer according to claim 1, wherein the relative positioning of the light emitter, the beamsplitter, the first and second mirrors, and the detector is so that a shortest light path from the light emitter to the detector via the beamsplitter to one of the first and second mirrors and back to the beamsplitter, is shorter than 90 mm, such as shorter than 80 mm, preferably shorter than 70 mm, such as shorter than 68 mm.

3. An interferometer according to any of the preceding claims, further comprising:
means, at a predetermined position of a light path between the emitter and the detector, for providing light to and receiving light from a sample, and
means for determining, on the basis of an output of the detector, a characteristic of the sample.

4. An interferometer according to claim 3, wherein:
the providing and receiving means are adapted to provide light to and receive light from a container means adapted to hold a liquid, powder, or fluid sample, and
the determining means are adapted to determine a concentration of at least one component of the sample.

5. An interferometer according to claim 4, where the shortest light path between the light emitter and the detector, apart from the position at the container, is present in air, and wherein this part of the shortest light path from the light emitter to the detector via the beamsplitter to one of the first and second mirrors and back to the beamsplitter, which is present in air, is shorter than 90 mm.

6. An interferometer according to claim 5, wherein this part, present in air, of the shortest light path is shorter than 80 mm, preferably shorter than 70 mm, such as shorter than 60 mm.

7. An interferometer according to claim 3, wherein the providing and receiving means are adapted to provide light to and receive light from a surface and direct the received light to the light detector.

8. An interferometer according to any of the preceding claims, wherein the beamsplitter is circular and has a diameter of at the most 20 mm, such as at the most 18 mm, preferably at the most 15 mm, such as at the most 12 mm.

9. An interferometer according to any of the preceding claims, wherein the beamsplitter has a thickness of at the most 3 mm, such as at the most 2 mm, preferably at the most 1.5 mm.

10. An interferometer according to any of the preceding claims, wherein the beamsplitter has an eigenfrequency of at least 1 kHz, such as at least 2 kHz, preferably at least 4 kHz, such as at least 10 kHz.

11. An interferometer according to any of the preceding claims, wherein the first and second mirrors are circular and have a diameter of at the most 14 mm, such as at the most 12 mm, preferably at the most 10 mm.

12. An interferometer according to any of the preceding claims, wherein the light detector has a light sensitive area of at least 1.5 mm², such as at least 2 mm², preferably at least 3 mm².

13. An interferometer according to any of the preceding claims, wherein the light emitter, the beamsplitter, the first and second mirrors, and the detector are positioned inside a single block of a material, such as a metal, preferably aluminium.

14. An interferometer according to any of the preceding claims, wherein one of the first and second mirrors is adapted to be translated along a direction between the mirror and the beamsplitter, the interferometer further comprising means for moving the mirror.

15. An interferometer according to claim 13 and 14, wherein the moving means are provided in another or the same block of material.

16. An interferometer according to claim 15, wherein the moving means are provided in another block, which is attached to the single block.

17. An interferometer according to claim 13, wherein the single block is rendered at least liquid tight.

18. An interferometer according to any of the preceding claims, wherein the light emitter comprises a filament comprising two end parts and a central part, wherein the central part is coiled in a manner so that no parts of the filament extend inside the coil and so that the two end parts extend from a same end of the coil.

19. An interferometer according to claim 18, wherein the two end parts extend at least substantially downwards in relation to the central part.

20. An interferometer according to any of the preceding claims, the interferometer being a Michelson interferometer.

21. A moving means for an interferometer, the moving means comprising a magnet part and a coil part for receiving a voltage/current in order to have the magnet part and the coil part exert a force there between, wherein the magnet part extends within the coil part.

22. A light emitter for an interferometer, the light emitter comprising a filament comprising two end parts and a central part, wherein the central part is coiled in a manner so that no parts of the filament extend inside the coil and so that the two end parts extend from a same end of the coil.

23. A method of providing an interferometer, the method comprising:
providing a block of one or more predetermined materials,
providing a first bore along a predetermined first direction in the block,
providing a second bore at a second direction at an angle to the first direction, the first and second bores intersecting at a predetermined point in the block,
providing a first mirror into the first bore at a first position thereof,
providing a light emitter into the first bore at a second position thereof,
providing a detector at a position where it is able to detect light travelling along the second bore,
providing a second mirror into the second bore at a first position thereof,
one of the first and second mirrors being movable in a direction along the direction of the first or second bore, respectively, respectively,
providing a beamsplitter into a bore and at the predetermined position, a direction of the beamsplitter being defined by the direction of the bore, and
adjusting the interferometer by adjusting the other of the first and second mirrors in relation to the direction of the first or second bore, respectively.

24. A method according to claim 23, the method further comprising providing a third bore in a predetermined angle in the block, the third bore extending to the predetermined point in the block, and wherein the step of providing the beamsplitter comprises providing the beamsplitter in the third bore.

25. A method according to claim 23 or 24, wherein:
the step of providing the first bore comprises providing the first bore as a first through-bore along the predetermined first direction in the block,
the step of providing the second bore comprises providing the second bore as a second through-bore along the second direction,
the step of providing the first mirror comprises providing the first mirror into the first though-bore from a first end thereof,
the step of providing the light emitter comprises providing the light emitter into the first through-bore from a second end thereof, and wherein
the step of providing the second mirror comprises providing the second mirror into the second through-bore from a first end thereof.

26. A method according to any of claims 23-25, wherein the step of providing the detector comprises providing the detector at a second position within the second bore, the method further comprising the step of providing means for having light travelling in the second bore interact with a sample and for re-introducing the light from the sample into the second bore.

27. A method according to any of claims 24-25, the method providing a Michelson interferometer, and wherein:
the step of providing the second bore comprises providing the second bore with the second direction being at least substantially perpendicular to the first direction,
the step of providing the third bore comprises providing the third bore along a third direction being at least substantially 45° to the first and second directions,
the step of providing the one of the first and second mirrors comprises providing the one mirror with a plane at least substantially perpendicular to the direction of the through-bore into which the mirror is provided,
the step of providing the other of the first and second mirrors comprises providing the other mirror so as to have a plane of the other mirror adjustable to be at least substantially perpendicular the direction of the through-bore into which the mirror is provided, and
the step of providing the beamsplitter comprises providing a beamsplitter having a plane being at least substantially perpendicular to the direction of the third bore.

28. A method according to any of claims 23-27, further comprising the step of providing a moving means adapted to move the one of the first and second mirrors,

29. A method according to claim 28, wherein the step of providing the moving means comprises providing the moving means into the first or second bore in the block.

30. A method according to claim 28, wherein the step of providing the moving means comprises providing the moving means in a separate block and attaching the block and the separate blocks to each other.

31. A method according to any of claims 23-30, the method comprising the step of closing or sealing the first, second, and third bores subsequent to the steps of providing the mirrors, beamsplitter and detector.

32. A method of making a light emitter, the method comprising:
providing a filament having a central part and two end parts,
shaping part of the central part into an S-shape,
coiling parts of the central part adjacent to the S-shaped part into bifilar coils having at one end thereof the S-shaped part and so that the end parts extend from another end of the coils.
